(19) United States
(12) Patent Application Publication
(10) Pub. No.: US 2021/0184721 A1
(43) Pub. Date: Jun. 17, 2021

(54) Compensator Module, Control Module, Data Transfer System and Method For Operating A Data Transfer System

(71) Applicant: Hirschmann Car Communication GmbH, Neckartenzlingen (DE)

(72) Inventors: Roland Boehmert, Neckartenzlingen (DE); Florian Storch, Neckartenzlingen (DE); Peter Schaich, Neckartenzlingen (DE)

(73) Assignee: Hirschmann Car Communication GmbH, Neckartenzlingen (DE)

(21) Appl. No.: 17/115,260

(22) Filed: Dec. 8, 2020

(30) Foreign Application Priority Data
Dec. 11, 2019 (DE) 102019134013.6

(51) Int. Cl. H04B 1/44; H04B 1/401; H04B 1/04; H04B 1/10

(52) U.S. Cl. CPC H04B 1/44; H04B 1/401; H04B 2001/0408; H04B 1/1027; H04B 1/0475

(57) ABSTRACT

A compensator module includes a wanted-signal connection for transferring a plurality of wanted signals, a radio-frequency module for amplifying the wanted signals, a control-data connection for receiving a plurality of control data, and a processing unit processing the control data and driving the radio-frequency module. The control-data connection is connected to a digital data network. The processing unit switches the radio-frequency module between a compensator-module transmit operating mode and a compensator-module receive operating mode according to the control data.

### CROSS-REFERENCE TO RELATED APPLICATION

This application claims the benefit of the filing date under 35 U.S.C. § 119(a)-(d) of German Patent Application No. 102019134013.6, filed on Dec. 11, 2019.

### FIELD OF THE INVENTION

The present invention relates to a data transfer system and, more particularly, to a compensator module of a data transfer system.

### BACKGROUND

A compensator module for compensating a cable loss is known in the prior art.

### SUMMARY

A compensator module includes a wanted-signal connection for transferring a plurality of wanted signals, a radio-frequency module for amplifying the wanted signals, a control-data connection for receiving a plurality of control data, and a processing unit processing the control data and driving the radio-frequency module. The control-data connection is connected to a digital data network. The processing unit switches the radio-frequency module between a compensator-module transmit operating mode and a compensator-module receive operating mode according to the control data.

### BRIEF DESCRIPTION OF THE DRAWINGS

The invention will now be described by way of example with reference to the accompanying Figures, of which:

FIG. 1 is a block diagram of a data transfer system according to an embodiment;

FIG. 2 is a block diagram of a radio-frequency module of a compensator module of the data transfer system; and

FIG. 3 is a block diagram of a system receive operating mode and a system transmit operating mode of the data transfer system.

### DETAILED DESCRIPTION OF THE EMBODIMENT(S)

Features and exemplary embodiments as well as advantages of the present disclosure will be explained in detail with respect to the drawings. It is understood that the present disclosure should not be construed as being limited by the description of the following embodiments. It should furthermore be understood that some or all of the features described in the following may also be combined in alternative ways.

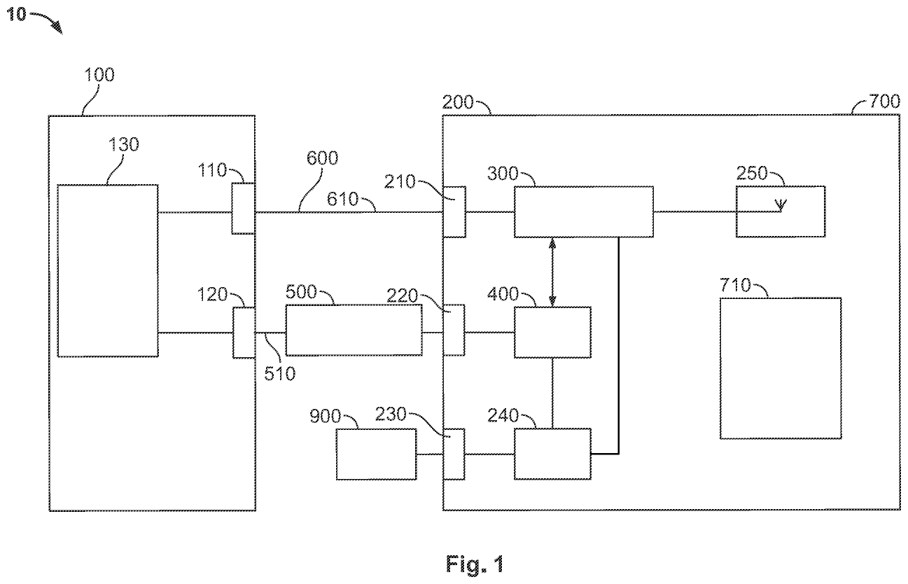

FIG. 1 shows a block diagram of a data transfer system 10 according to an embodiment. The data transfer system 10 may be arranged in a motor vehicle, for example, and may be used for vehicle-to-everything (V2X) communication, for example. The data transfer system 10 includes a control module 100 and a compensator module 200. The control module 100 and the compensator module 200 can be arranged separately from one another at different positions in a motor vehicle.

The control module 100, as shown in FIG. 1, includes a transfer unit 130. The transfer unit 130 can include a baseband processor, for example. The transfer unit 130 is designed to emit and receive radio-frequency wanted signals 610. The transfer unit 130 emits and receives the radio-frequency wanted signals 610 alternately in time. If the control module 100 is in a control-module transmit operating mode 810, which is shown schematically in FIG. 3, then the transfer unit 130 of the control module 100 is emitting wanted signals 610. If the control module 100 is in a control-module receive operating mode 811, which is shown schematically in FIG. 3, then the transfer unit 130 of the control module 100 is receiving the wanted signals 610. The control-module transmit operating mode 810 and the control-module receive operating mode 811 alternate in time. The wanted signals 610 may lie, for example, in an ultra high frequency (UHF) transmit frequency band or a super high frequency (SHF) transmit frequency band, for instance in a transmit frequency band that includes a frequency of 5.9 GHz.

The control module 100 has a wanted-signal connection 110, as shown in FIG. 1. The control module 100 is connected via the wanted-signal connection 110 to an antenna cable 600. The antenna cable 600 may be a coaxial cable, for instance. The transfer unit 130 is connected to the wanted-signal connection 110 such that the transfer unit 130 can emit and receive the wanted signals 610 via the wanted-signal connection 110.

The control module 100 also includes a control-data connection 120, as shown in FIG. 1. The control module 100 is connected via the control-data connection 120 to a digital data network 500. The digital data network 500 may be an Ethernet-based data network, a media oriented systems transport (MOST) data network or a controller area network (CAN) data network, for example. This advantageously makes it possible to transfer the control data 510 via a data network that already exists for other purposes, allowing the compensator module 200 to be installed particularly simply and economically. The control module 100 can exchange data via the digital data network 500 with other modules that are likewise connected to the digital data network 500.

The transfer unit 130 of the control module 100 is designed to emit via the control-data connection 120 control data 510 that indicates whether the control module 100 is in the control-module transmit operating mode 810 or in the control-module receive operating mode 811. For this purpose, the transfer unit 130 of the control module 100 can emit corresponding control data 510 via the control-data connection 120 whenever there is a change between the control-module transmit operating mode 810 and the control-module receive operating mode 811. The transfer unit 130 of the control module 100 can also emit control data 510 periodically indicating whether, at that precise time at which the control data 510 is being emitted, the control module 100 is in the control-module transmit operating mode 810 or in the control-module receive operating mode 811.

As FIG. 1 shows, the compensator module 200 has a wanted-signal connection 210, a radio-frequency module 300, and an antenna 250. The wanted-signal connection 210 of the compensator module 200 is connected to the antenna cable 600. The wanted-signal connection 210 of the compensator module 200 is thereby connected via the antenna cable 600 to the wanted-signal connection 110 of the control module 100. The radio-frequency module 300 of the compensator module 200 is connected to the wanted-signal connection 210 and to the antenna 250, and is arranged between the wanted-signal connection 210 and the antenna 250. Compensation of cable losses that is performed by the compensator module 200 advantageously takes place close to the antenna 250.

The compensator module 200 is designed such that in a compensator-module transmit operating mode 820 of the compensator module 200, which operating mode is shown schematically in FIG. 3, it receives via the wanted-signal connection 210 of the compensator module 200 wanted signals 610 emitted by the control module 100 via the wanted-signal connection 110 of the control module 100 and the antenna cable 600, and it emits said wanted signals via the antenna 250 of the compensator module 200. In addition, the compensator module 200 is designed such that in a compensator-module receive operating mode 821 of the compensator module 200, which operating mode is shown schematically in FIG. 3, it receives wanted signals 610 via the antenna 250 of the compensator module 200, and transfers these wanted signals to the control module 100 via the radio-frequency module 300, the wanted-signal connection 210 of the compensator module 200, the antenna cable 600 and the wanted-signal connection 110 of the control module 100.

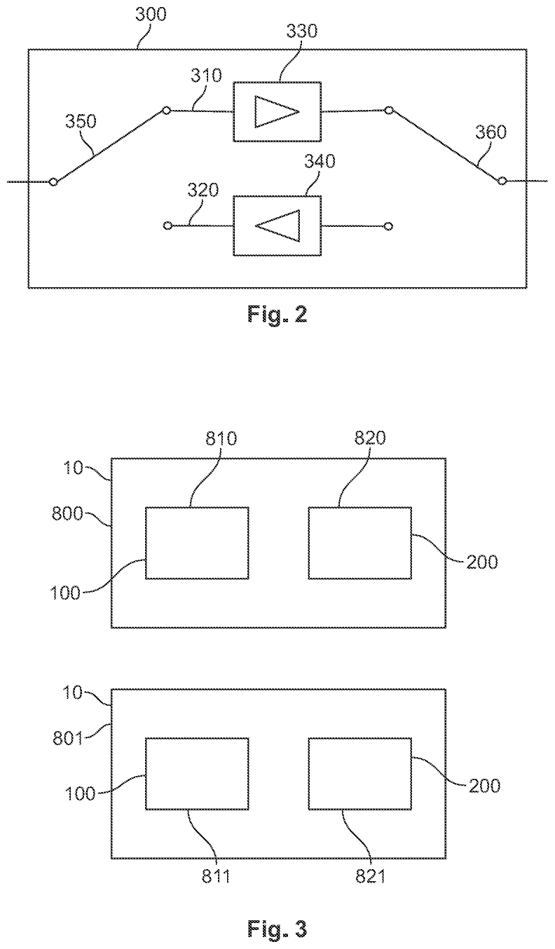

FIG. 2 shows a block diagram of the radio-frequency module 300 of the compensator module 200 without the other components of the compensator module 200. The radio-frequency module 300 of the compensator module 200 has a transmit path 310, via which the wanted signals 610 are routed from the wanted-signal connection 210 to the antenna 250 in the compensator-module transmit operating mode 820. The radio-frequency module 300 also comprises a receive path 320, via which the wanted signals 610 are routed from the antenna 250 to the wanted-signal connection 210 in the compensator-module receive operating mode 821.

The antenna cable 600 arranged between the control module 100 and the compensator module 200 of the data transfer system 10 may have a long length, for instance a length of several meters. As a result, in the control-module transmit operating mode 810 of the control module 100, wanted signals 610 emitted by the control module 100 are attenuated or weakened in the antenna cable 600. This attenuation of the wanted signals 610 must be compensated in the compensator module 200 in order that the wanted signals 610 can be emitted via the antenna 250 of the compensator module 200 at a specified signal strength.

In order to compensate the attenuation of the wanted signals 610 emitted by the control module 100 that occurs in the antenna cable 600, the wanted signals 610 are amplified in the radio-frequency module 300 of the compensator module 200. In the example shown schematically in FIGS. 1 and 2, the radio-frequency module 300 has for this purpose a power amplifier 330 arranged in the transmit path 310. The radio-frequency module 300 could also comprise other and/or additional amplifiers, however. In addition, the radio-frequency module 300 could comprise, for example, an attenuator arranged in the transmit path 310 and having an adjustable attenuation, as an effective means of adapting the amplification of the wanted signals 610 performed by the radio-frequency module 300 to suit different cable attenuations.

In the example shown schematically in FIGS. 1 and 2, the radio-frequency module 300 of the compensator module 200 also has a low-noise amplifier 340 arranged in the receive path 320 of the radio-frequency module 300. The low-noise amplifier 340 is intended to amplify, in the compensator-module receive operating mode 821 of the compensator module 200, the wanted signals 610 received via the antenna 250, before the wanted signals 610 are passed to the control module 100 via the wanted-signal connection 210 of the compensator module 200, the antenna cable 600 and the wanted-signal connection 110 of the control module 100. The radio-frequency module 300 could alternatively also comprise other or additional amplifiers and components arranged in the receive path 320. The low-noise amplifier 340 can also be omitted or can be bypassed.

The compensator module 200 has a control-data connection 220 and a processing unit 400, as shown in FIG. 1. The control-data connection 220 is connected to the digital data network 500, to which the control-data connection 120 of the control module 100 is also connected. The control module 100 and the compensator module 200 are thereby connected to one another via the digital data network 500 and can exchange data via the digital data network 500.

The processing unit 400 of the compensator module 200 can comprise a processor or a microcontroller. The processing unit 400 is designed to receive, via the control-data connection 220 of the compensator module 200, and process the control data 510 emitted by the control module 100, which control data indicates whether the control module 100 is in the control-module transmit operating mode 810 or in the control-module receive operating mode 811. The processing unit 400 is designed to switch the compensator module 200 between the compensator-module transmit operating mode 820 and the compensator-module receive operating mode 821 according to the received control data 510. In this process, the processing unit 400 switches the compensator module 200 into the compensator-module transmit operating mode 820 if the control data 510 received from the control module 100 indicates that the control module 100 is in the control-module transmit operating mode 810. In a corresponding manner, the processing unit 400 switches the compensator module 200 into the compensator-module receive operating mode 821 if the control data 510 received from the control module 100 indicates that the control module 100 is in the control-module receive operating mode 811. In the compensator module 200, the control data 510 is transferred separately from the wanted signals 610. The compensator module 200 can thereby advantageously have a particularly simple design.

As a result, the data transfer system 10 comprising the control module 100 and the compensator module 200 is either in a system transmit operating mode 800, which is shown schematically in FIG. 3, or in a system receive operating mode 801, which is shown schematically in FIG. 3. In the system transmit operating mode 800, the control module 100 is in the control-module transmit operating mode 810, and the compensator module 200 is in the compensator-module transmit operating mode 820. In the system receive operating mode 801, the control module 100 is in the control-module receive operating mode 811, and the compensator module 200 is in the compensator-module receive operating mode 821.

The switching of the compensator module 200 between the compensator-module transmit operating mode 820 and the compensator-module receive operating mode 821 performed by the processing unit 400 comprises switching the radio-frequency module 300 between the transmit path 310 and the receive path 320. The switching between the transmit path 310 and the receive path 320 can be performed by a first switch 350 and a second switch 360, for instance, as shown schematically in FIG. 2. In the compensator-module transmit operating mode 820, the transmit path 310 of the radio-frequency module 300 is active. In the compensator-module receive operating mode 821, the receive path 320 of the radio-frequency module 300 is active.

The compensator module 200 has a voltage-supply connection 230, as shown in FIG. 1, which is intended to be connected to an external voltage-supply unit 900. The compensator module 200 can obtain a supply voltage from the external voltage-supply unit 900 via the voltage-supply connection 230, and provide this supply voltage by an internal voltage-supply unit 240 to the components of the compensator module 200, for instance to the processing unit 400 and to the radio-frequency module 300.

The compensator module 200 can be designed to detect one or more measured values, which it transfers to the processing unit 400 and processes by the processing unit 400. For example, the compensator module 200 can be designed to detect a temperature of the power amplifier 330, a temperature of the low-noise amplifier 340 or another temperature. The compensator module 200 can also be designed to determine a signal level of the wanted signals 610 received from the control module 100 in the system transmit operating mode 800.

The compensator module 200 can be designed such that the processing unit 400 drives the radio-frequency module 300 according to one or more detected measured values. For example, the processing unit may adjust a gain of the power amplifier 330 or of the low-noise amplifier 340 or an attenuation of an attenuator of the radio-frequency module 300 according to one or more measured values.

It can also be provided that the processing unit 400 transfers one or more detected measured values via the control-data connection 220 and the digital data network 500 to the control module 100 or to other network nodes of the digital data network 500.

The compensator module 200 of the data transfer system 10 may be integrated in a motor vehicle control unit 700 intended for another purpose, or may form part of this control unit 700. In this case, individual components of the compensator module 200 in the control unit 700 can also be used for other purposes. For example, the control-data connection 220, the processing unit 400, the voltage-supply connection 230 and the internal voltage-supply unit 240 can also be used for other functions of the control unit 700. Thus the internal voltage-supply unit 240 can also supply other components of the control unit 700 with a supply voltage. The processing unit 400 can also drive other components of the control unit 700. Data other than the control data 510 used by the compensator module 200 can also be exchanged with the digital data network 500 via the control-data connection 220.

The control unit 700 can comprise further components in addition to the described components of the compensator module 200. For example, as shown in FIG. 1, the control unit 700 can comprise one or more additional antennas 710, for instance a mobile communications antenna, a radio antenna and/or a global navigation satellite system (GNSS) antenna.

In the data transfer system 10, control data 510 can advantageously be exchanged between the control module 100 and the compensator module 200 via the digital data network 500. At the same time, the control module 100 and the compensator module 200 can exchange wanted data via their wanted-signal connections 110, 210. The separation of wanted signals 610 and control data 510 advantageously allows the compensator module 200 and the control module 100 of this data transfer system 10 to have a particularly simple design.

In a method for operating the data transfer system 10, the control module 100 emits via its control-data connection 120 control data 510 that indicates whether the control module 100 is in the control-module transmit operating mode 810 or in the control-module receive operating mode 811. The compensator module 200 receives the control data 510 via its control-data connection 120. The processing unit 400 of the compensator module 200 switches the radio-frequency module 300 of the compensator module 200 between the compensator-module transmit operating mode 810 and the compensator-module receive operating mode 811 according to the control data 510. This method advantageously allows the data transfer system 10 to be operated particularly simply.

What is claimed is:

1. A compensator module, comprising:
a wanted-signal connection for transferring a plurality of wanted signals;
a radio-frequency module for amplifying the wanted signals;
a control-data connection for receiving a plurality of control data; and
a processing unit processing the control data and driving the radio-frequency module, the control-data connection is connected to a digital data network, the processing unit switches the radio-frequency module between a compensator-module transmit operating mode and a compensator-module receive operating mode according to the control data.

2. The compensator module of claim 1, further comprising an antenna emitting and receiving the wanted signals.

3. The compensator module of claim 1, wherein the digital data network is an Ethernet-based data network, a MOST data network, or a CAN data network.

4. The compensator module of claim 1, wherein the wanted-signal connection is connected to an antenna cable.

5. The compensator module of claim 1, wherein the radio-frequency module has a transmit path containing a power amplifier and a receive path containing a low-noise amplifier.

6. The compensator module of claim 5, wherein the transmit path is used in the compensator-module transmit operating mode and the receive path is used in the compensator-module receive operating mode.

7. The compensator module of claim 1, wherein the processing unit is a processor or a microcontroller.

8. The compensator module of claim 1, wherein the compensator module detects a measured value and transfers the measured value to the processing unit.

9. The compensator module of claim 8, wherein the processing unit transfers the measured value via the control-data connection.

10. The compensator module of claim 8, wherein the processing unit drives the radio-frequency module according to the measured value.

11. The compensator module of claim 1, wherein the compensator module has a voltage-supply connection.

12. The compensator module of claim 1, wherein the compensator module is integrated in a control unit that is fit in a motor vehicle.

13. The compensator module of claim 12, wherein the control unit has an integral mobile communications antenna, an integral radio antenna, and/or an integral GNSS antenna.

14. A control module, comprising:
a wanted-signal connection;
a control-data connection; and
a transfer unit designed alternately to emit a plurality of wanted signals via the wanted-signal connection in a control-module transmit operating mode and to receive a plurality of wanted signals via the wanted-signal connection in a control-module receive operating mode, the control-data connection is connected to a digital data network, the transfer unit emits via the control-data connection a plurality of control data that indicates whether the control module is in the control-module transmit operating mode or in the control-module receive operating mode.

15. A data transfer system, comprising:
a compensator module including a wanted-signal connection for transferring a plurality of wanted signals, a radio-frequency module for amplifying the wanted signals, a control-data connection for receiving a plurality of control data, and a processing unit processing the control data and driving the radio-frequency module; and
a control module including a wanted-signal connection, a control-data connection, and a transfer unit designed alternately to emit the wanted signals via the wanted-signal connection of the control module in a control-module transmit operating mode and to receive the wanted signals via the wanted-signal connection of the control module in a control-module receive operating mode, the transfer unit emits via the control-data connection of the control module the control data that indicates whether the control module is in the control-module transmit operating mode or in the control-module receive operating mode, the wanted-signal connection of the compensator module is connected to the wanted-signal connection of the control module, the control-data connection of the compensator module and the control-data connection of the control module are connected to a shared digital data network, the processing unit switches the radio-frequency module between a compensator-module transmit operating mode and a compensator-module receive operating mode according to the control data.

16. A method for operating a data transfer system, comprising:
providing the data transfer system including:
a compensator module including a wanted-signal connection for transferring a plurality of wanted signals, a radio-frequency module for amplifying the wanted signals, a control-data connection for receiving a plurality of control data, and a processing unit processing the control data and driving the radio-frequency module; and
a control module including a wanted-signal connection, a control-data connection, and a transfer unit designed alternately to emit the wanted signals via the wanted-signal connection of the control module in a control-module transmit operating mode and to receive the wanted signals via the wanted-signal connection of the control module in a control-module receive operating mode;
emitting from the control module the control data that indicates whether the control module is in the control-module transmit operating mode or in the control-module receive operating mode;
receiving the control data at the compensator module via the control-data connection of the compensator module; and
switching the radio-frequency module between a compensator-module transmit operating mode and a compensator-module receive operating mode with the processing unit according to the control data.
